(19) United States
(12) Patent Application Publication
(10) Pub. No.: US 2020/0182275 A1
(43) Pub. Date: Jun. 11, 2020

(54) AUTOMOTIVE TRANSMISSION PLUG

(71) Applicants: Thomas Eugene Wolfe, Lebanon, PA (US); Jesse James Dunkleberger, Lebanon, PA (US)

(72) Inventors: Thomas Eugene Wolfe, Lebanon, PA (US); Jesse James Dunkleberger, Lebanon, PA (US)

(21) Appl. No.: 16/211,234

(22) Filed: Dec. 6, 2018

(51) Int. Cl. F16B 7/04; F16H 57/029; F16J 15/02

(52) U.S. Cl. CPC F16B 7/0406; F16H 2057/0093; F16J 15/021; F16H 57/029

(57) ABSTRACT

A device for sealing a transmission is presented. The device has a base with an upper surface and a lower surface. The device further has a protruding portion. The protruding portion has an inner surface and an outer surface. The protruding portion has a predetermined length. The protruding portion is attached to the base of the device. A locking mechanism is also presented to lock the protruding portion to the base. The locking mechanism is made of a plurality of locking members. Each of the locking member is positions apart from the protruding portion and is located around a periphery of the base of the device.

### FIELD OF THE INVENTION

This invention relates to automotive transmissions. More particularly, it relates to automobile transmission plugs.

### BACKGROUND

A substantial problem is encountered in servicing automobile transmissions or similar types of vehicles having fluid filled transmission housings when it becomes necessary to disconnect a vehicle driveshaft from the transmission associated therewith.

Generally, transmissions of this nature include an output shaft disposed in an extension housing of the transmission which extends through an aperture in the wall of the housing for connection with a drive shaft.

Usually, the aperture in the extension housing includes an annular sealing means through which an internally splined end portion of a driveshaft is inserted to engage a corresponding, externally splined end portion of the transmission output shaft. The sealing means in the transmission wall engages the outer surface of the driveshaft end portion to preclude loss of transmission fluid or oil maintained within the housing of such transmission.

However, when it becomes necessary to disconnect the driveshaft from the transmission, for example during servicing thereof, there necessarily is a substantial loss of fluid therefrom in view of the unrestricted annular opening between the transmission output shaft and concentrically disposed sealing means associated therewith.

### BRIEF DESCRIPTION OF THE DRAWINGS

FIG. 1 is a view of an exemplary plug for a transmission.

FIG. 2 is a first perspective of the exemplary plug for a transmission of FIG. 1.

FIG. 3 is a second perspective of exemplary plug for a transmission of FIG. 1.

FIG. 4 is an exemplary example of the use of the exemplary plug for a transmission.

### DETAILED DESCRIPTION

Reference will now be made in detail to the present preferred embodiments, examples of which are illustrated in the accompanying drawings. All terms in the plural shall also be taken as singular and vice-versa. Further, any reference to he shall also be applicable to she and vice-versa.

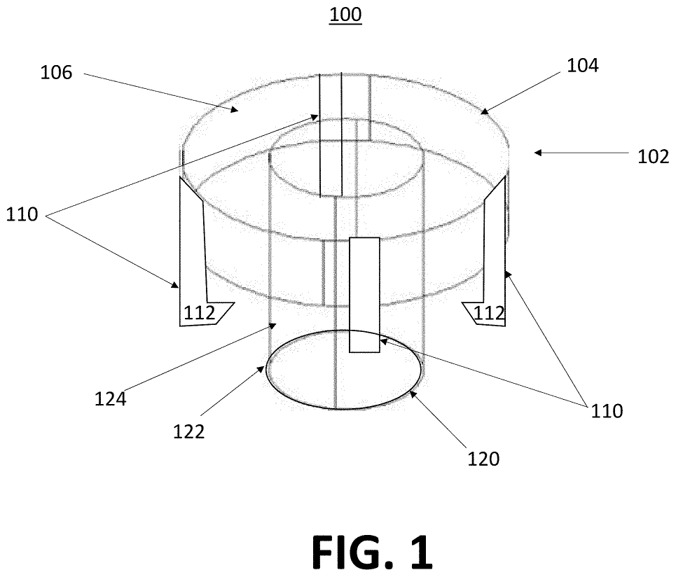

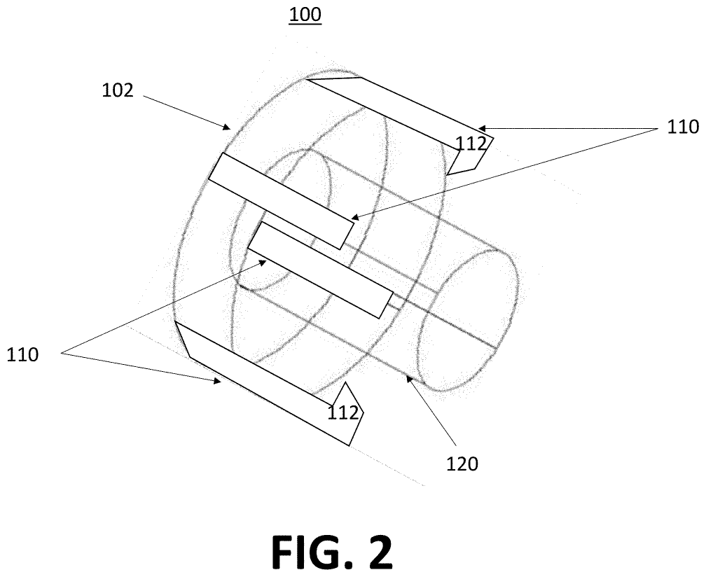

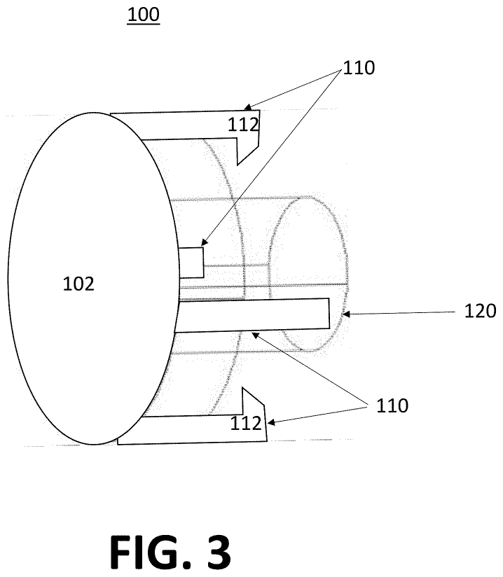

Referring to FIG. 1, a plug 100 for a transmission is shown. FIG. 2 and FIG. 3 show the plug 100 at different perspectives. The plug 100 is useful for sealing a transmission when the transmission has been removed from an automobile to be worked on. The transmission of the automobile generally leaks a large amount of fluid as the transmission is being worked on. The plug 100 is useful to reduce and halt the leakage of fluid from the removed transmission, thus being better for the environment and easing the conditions for a worker to repair the transmission.

The plug 100 has a base 102. The base 102 of the plug 100 has an upper surface 104 and a lower surface 106. The base 102 may be of any shape such as disc-shaped, oval, circular, square, etc.

The base 102 of the plug 100 has a protruding member 120. The protruding member 120 in an embodiment is cylindrical, although the protruding member 120 may be any shape which corresponds to the opening in a rear output shaft of the transmission. The protruding member 120 is preferably solid but may be hollow, semi-solid, etc. The protruding member 120 may be open on one end, both ends, or neither end.

The protruding member 120 has an inner surface 122 and an outer surface 124. The protruding member 120 being attached to the base 102 such that the protruding member 120 is only movable by also moving the base 102. The protruding member 120 may be coupled to the base 102 at various points, such as the end points, center point, etc. of the base 102. It is preferably and shown that the protruding member 120 is attached to the center point of the base 102.

Further, the protruding member 120 may be preferably attached to the upper surface 104 of the base 102, but may be coupled or attached to the lower surface 106 of the base 102 or between the upper surface 104 of the base 102 and the lower surface 106 of the base 102.

The inner surface 122 of the protruding member 120 preferably has ridges but may be smooth, be a pattern, etc. The outer surface 124 of the protruding member 120 preferably is smooth, but may be ridged, be patterned, etc.

The plug 100 further has a plurality of locking members 110. The plurality of locking members 110 may be of any number greater than two, but preferably an even number to help insure a more secure locking mechanism. It is preferable to have four, evenly spaced locking members.

The plurality of locking members 110 are generally situated and attached to the base 102 along a periphery of the base 102 and preferably situated apart from the protruding member 120 that is attached to the base 102. Preferably, the plurality of locking members 110 is spaced evenly around the base 102 of the plug 100, but may be spaced unevenly around the base 102 of the plug 100.

Each of the plurality of locking members 110 has a head portion 112. The head portion 112 is used to clip onto the rear output shaft, or thereabout, of the transmission to secure the plug 100 onto the rear output shaft of the transmission to prevent the plug 100 from disengaging from the transmission and allowing leakage of fluid.

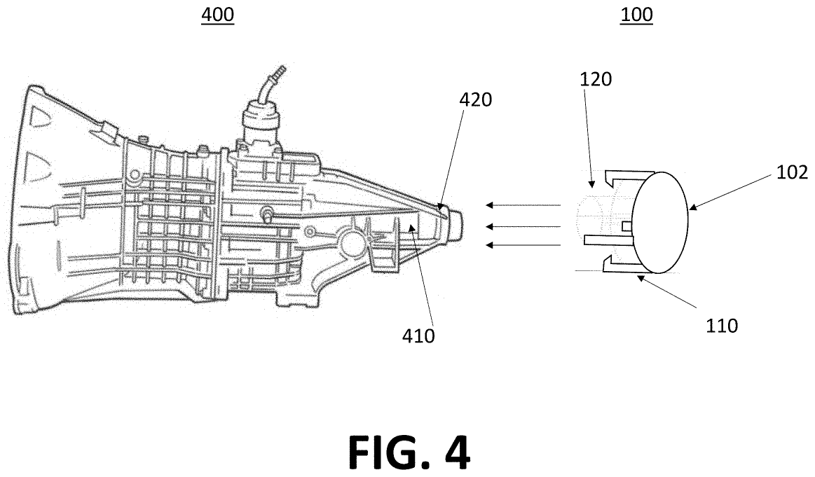

Moving now to FIG. 4, an example of the use of the exemplary plug 100 for a transmission 400 is shown. The plug 100 is shown in a pre-engaged position with respect to the end of the rear output shaft 410 and seal 420.

In utilizing the plug 100, it is to be understood that when a driveshaft of a vehicle is disconnected from its splined connection with the rear output shaft 410, an annular opening would exist between the rear output shaft splines and seal 420. In this condition, a good deal of oil or fluid normally maintained within the transmission housing could flow outwardly and be lost.

However, the plug 100 can be inserted over the end of rear output shaft 410 immediately after disconnection of a driveshaft so as to minimize any loss of fluid and preclude any further potential flow and loss of transmission fluid over the transmission output shaft 410 and through the opening in the right-hand end wall of the transmission 400. The protruding member 120 of the plug 100 facilitate sliding engagement thereof through the seal 420.

In this manner, seal 420 engages the outer surface of a protruding member 120 of the plug 100 so that fluid is retained in the housing with fluid passing into the protruding member 120 being retained or choked off by the transversely disposed fluid barrier of the base 102.

The plurality of locking members 110 clip or engage with the outer side of the rear output shaft 410 to lock the plug 100 into the rear output shaft 410 of the transmission 400 in a secure manner.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An apparatus for sealing a transmission, said apparatus comprising:
a base having an upper surface and a lower surface;
a protruding member, said protruding member having an inner surface, an outer surface, and a predetermined length and wherein said protruding member is attached to said base; and
a plurality of locking members, each of said plurality of locking members positioned apart from said protruding member and located around a periphery of said base.

2. The apparatus of claim 1, wherein each of said plurality of locking members are positioned in an equally spaced-apart configuration around a periphery of said base.

3. The apparatus of claim 1, wherein said base is a disc-shaped base.

4. The apparatus of claim 1, wherein said protruding member is attached to said upper surface of said base.

5. The apparatus of claim 4, wherein said protruding member is attached to a center portion of said upper surface of said base.

6. The apparatus of claim 1, wherein said protruding member is hollow.

7. The apparatus of claim 1, wherein said protruding member is open on one end.

8. The apparatus of claim 1, wherein said protruding member is cylindrical in shape.

9. The apparatus of claim 1, wherein said plurality of locking members comprises 4 locking members.

10. The apparatus of claim 1, wherein said plurality of locking members are rigid.

11. The apparatus of claim 1, wherein each of said plurality of locking members has a head portion.

12. The apparatus of claim 1, wherein said inner surface of said protruding member has ridges.

13. The apparatus of claim 1, wherein said outer surface of said protruding member is smooth.

14. An apparatus for sealing a transmission, said apparatus comprising:
a base having an upper surface and a lower surface;
a protruding member, said protruding member having an inner surface, an outer surface, and a predetermined length and wherein said protruding member is attached to said base; and
a plurality of locking members, each of said plurality of locking members positioned apart from said protruding member and located around a periphery of said base.
wherein each of said plurality of locking members are positioned in an equally spaced-apart configuration around a periphery of said base.
wherein said base is a disc-shaped base.
wherein said protruding member is attached to said upper surface of said base.
wherein said protruding member is attached to a center portion of said upper surface of said base.
wherein said protruding member is hollow.
wherein said protruding member is open on one end.
wherein said protruding member is cylindrical in shape.
wherein said plurality of locking members comprises 4 locking members.
wherein said plurality of locking members are rigid.
wherein each of said plurality of locking members has a head portion.
wherein said inner surface of said protruding member has ridges.
wherein said outer surface of said protruding member is smooth.
